(19) United States
(12) Patent Application Publication
(10) Pub. No.: US 2005/0029497 A1
(43) Pub. Date: Feb. 10, 2005

(54) Electrically conducting material

(76) Inventor: Susanne Rubel, Karlsbad (DE)

Correspondence Address: NATH & ASSOCIATES, PLLC, Sixth Floor, 1030 15th Street, N.W., Washington, DC, 20005-1503, US

(21) Appl. No.: 10/912,584

(22) Filed: Aug. 6, 2004

(30) Foreign Application Priority Data
Aug. 7, 2003 (DE) 103 37 748.4

(51) Int. Cl. H01B 1/00

(52) U.S. Cl. 252/500

(57) ABSTRACT

The invention relates to an electrically conducting material, in particular an electrically conducting varnish, for the preparation, preferably by electro-deposition, of dental moldings. This material comprises at least one component which brings about the electrical conductivity and one dental spacer or die spacer or the constituents of such a spacer. The material preferably comprises at least one additional component, in particular at least one colorant, which gives rise to an alteration in color or a change in color when the electrically conducting material is dried.

The invention relates first and foremost to an electrically conducting material for the preparation, preferably by electrodeposition, of dental moldings. The electrically conducting material is in particular a “conducting varnish” or “conducting lacquer”.

In the dental field, prosthetic parts or moldings are today, in a standard way, prepared with the help of the electrodeposition of metals. In this connection, use is made, in “electroforming”, mainly of noble metals, such as, e.g., gold and gold alloys. The molded articles/moldings prepared in this way can be used for known purposes in dentistry and dental technology, in particular as “dental frameworks” on which ceramic or plastic is then applied. Moldings used in double crown and bridge technology and as “supraconstructions” and the like are also prepared by electrodeposition.

Before the electrodeposition in the electrolyte, the surface intended to be subjected to electrodeposition is, independently of the intended use of the moldings/molded articles prepared by electro-deposition, provided with a conductive layer of an electrically conducting material, frequently a “conducting varnish”. These conducting substances are varnish-like liquids or pastes and preferably comprise noble metals (e.g. silver) in the form of a fine powder/spangles as conducting component, as well as various kinds of organic binders and solvents.

The application of the conducting layer can be carried out in various ways but it is at present usually applied with a brush or a felt pen (similar to an Edding) or by the airbrush method. In this connection, it is used, on nonconducting supports (e.g. plaster, plastics, ceramic), to establish the conductivity of the surface. With conducting supports, such as, e.g., metals or alloys, it is also used as conducting intermediate layer which makes possible the separation of the electrodeposited layer from the support/stump (die) material. In both cases, after the separation of the electrodeposited layer from the support/stump (die) material, most of the conducting silver layer remains on the electrodeposited layer.

As already mentioned, the various (electrically) nonconducting or (electrically) conducting supports are used in the preparation of dental moldings, in particular in the preparation of dental moldings by electrodeposition. In technical terminology, these supports are also described as stump or die materials since they reproduce the prepared oral situation, i.e. the tooth stump or stumps, as positive mold, prepared by the dental technician, of the impression (negative mold) taken by the dentist.

An electrically conducting material, e.g. the conducting varnish, usable in the dental field must correspondingly be able to be applied to all supports mentioned and must form a conducting layer thereon. Thus, the very frequently used support plaster is itself nonconducting but absorbent. This means that a portion of the conducting varnish soaks into the porous plaster material and the remaining part of the conducting varnish evaporates on drying. Because of this, the drying time of the conducting varnish on plaster is considerably shorter than on nonabsorbent materials. Furthermore, the adherence of the conducting varnish is favored by the porous surface of the plaster with a degree of roughness and is because of this, for example, better than on very smooth supports, such as, for example, plastics. In addition, with plastics as supports, the drying times with respect to plaster as support are comparatively great due to the low absorbency.

Ceramic as support is likewise nonconducting and normally has an extremely smooth surface with closed porosity. Here also, this results in an adherance of the conducting varnish to the surface which is made more difficult and in greater drying times due to the poor absorbency.

Metals as support are also nonabsorbent. In addition, their surfaces for the use as support are generally carefully polished. The result thereof is that metals as supports have the longest drying times for the conducting varnish and the lowest adhesive forces. Accordingly, metal supports which are provided with a conducting varnish as separator for forming a gap, mainly for better separation of an electrodeposited metal layer (secondary component) from the metal support (primary component), place the highest demands on a conducting varnish used in the dental field.

The varied properties of the supports used in the dental field result in a large number of requirements for an electrically conducting material usable in this field, such as a “conducting varnish”. The most important of these requirements are briefly listed below.
The drying time of the conducting varnish on the support should be not more than a few hours, preferably less than one hour. In this connection, a completely dried conducting layer has to be formed inside this period of time and furthermore over the entire surface of the support. Only then is a uniform conductivity and accordingly a uniform layer thickness and layer quality of the electrodeposited metal on the support guaranteed.
The adherence of the conducting varnish to the support has to be satisfactory, and furthermore likewise over the entire surface of the support. Only a good adherence of the conducting varnish to the support guarantees a good fit of the electro-deposited metal to the support. Should the growing electrodeposited metal layer be lifted off because of decreased or poor adhesion of the conducting varnish to the support, this fit is thus no longer provided. Infiltration of the conducting layer by the electrolytes for the electrodeposition must be prevented.
The conducting varnish must provide a uniformly high (electrical) conductivity over the entire conducting layer formed. Only then is the electro-deposition current in the metal deposition uniformly distributed in the generally three-dimensional surface and does it accordingly guarantee the growth of a qualitatively homogeneous metal layer with an equal layer thickness at all points.
The conducting varnish has to be satisfactory to handle by the user (generally dentists and dental technicians, and their staff). This concerns, first, the consistency of the conducting varnish, which has to make possible easy application with conventional methods. Secondly, it should be possible for the user in a simple way to assess the thickness of the conducting layer applied and its drying condition.
After the electrodeposition, the conducting varnish should come away without any problems from the support and, secondly, should be able to be separated from the electrodeposited metal layer without leaving a residue. An excessively strong adherence of the conducting varnish to the support would result in the conducting varnish having to again be separated from the support, for example by mechanical treatment. Residues from the conducting varnish on the electrodeposited layer would result, as impurity, in disadvantages in the further use of the electrodeposited components.

For all that, it must be taken into consideration that the electrodeposition and accordingly also the application of the conducting varnish is carried out by users without specialist chemical-technical knowledge. Neither specialists in electrodeposition nor specialists in varnishing are concerned here but, as mentioned, dentists, dental technicians and their staff. The commercial apparatuses used for the electrodeposition process are to a large extent automated, so that the process parameters appearing there should in particular not be individually adjusted by the user. Accordingly, the formation of the conducting layer on the respective support must also be able to be carried out as simply as possible with a reproducible result.

In view of the previous remarks, it is an object of the invention to make available an electrically conducting material, in particular a conducting varnish, for the preparation of dental moldings preferably by the electrodeposition route which takes into account to the greatest possible extent the abovementioned requirements. In particular, this electrically conducting material should be suitable for supports of the most varied kind and should exhibit, on these supports, in comparison with conducting materials used at present, drying times which are reduced as much as possible and an improved adherence and/or conductivity. In this connection, the conducting material should be at least as easy to handle as the conducting materials used earlier. In addition, it should be an object of the invention to make available to the user a monitoring parameter which makes it possible for him to assess as much as possible, during and after the application, the quality of the conducting layer applied.

This object is achieved by the electrically conducting material, in particular the conducting varnish, with the features of claim 1. Preferred embodiments of this material are represented in the dependent claims 2 to 17. The subject-matter of the invention likewise includes the use as claimed in claim 18 and a dental spacer as claimed in claim 19 with its embodiments of claims 20 to 23. The wording of all the claims is herewith made with reference to the content of this description.

This object is achieved by an electrically conducting material, in particular a conducting varnish, mentioned at the start which comprises at least one component which brings about the electrical conductivity and one “die spacer” or “dental spacer” or the constituents of such a spacer. To be exact, it has been established, surprisingly, that the addition of a component which brings about the electrical conductivity to a spacer or to the components of such a spacer results in a new conducting material/conducting varnish with improved properties.

“Spacers” or “die spacers” are known to specialists in the dental field, in particular to dental technicians. They are used essentially in two main fields of application. First, plaster or plastic stumps are protected by such spacers from abrasion and inaccuracies resulting therefrom during the preparation of the replacement tooth. In the case of plaster stumps, “plaster hardeners” in the form of varnishes can be used, in addition, for surface sealing. Secondly, a defined gap (function of the separator) for the cementing or the adhesive attachment of the replacement tooth is produced by the application of spacers. The thickness of the gap (i.e. the space produced by the separator) is controlled by the addition of fillers to these spacers.

The conducting material according to the invention, which is to be described subsequently (without implied limitation) for reasons of simplicity only as conducting varnish, can be prepared and formulated in various ways from its individual components.

Thus, in a first preferred embodiment, it is possible to prepare the conducting varnish from the component which brings about the electrical conductivity and a finished die spacer. The spacer in this connection is to be understood as a ready-to-use product, i.e. inclusive of solvent. The solvent component of the spacer can in this connection be added completely or partially to the remaining varnish components (for example, in the form of a “thinner”) immediately before or during the mixing with the component which brings about the electrical conductivity. These embodiments can according to the invention be modified in particular by mixing the component which brings about the conductivity with at least one solvent/solvent mixture/thinner and one finished die spacer.

In a second preferred embodiment of the conducting varnish according to the invention, the latter is prepared from a current commercial conducting varnish (i.e. according to the state of the art), which already comprises the component which brings about the electrical conductivity, and a finished die spacer. This embodiment has the advantage that two already finished products can be mixed with one another to prepare the conducting varnish according to the invention. Such embodiments can optionally be modified by adding, to the two finished varnishes, in addition, a further electrically conducting material or a further solvent in order to adjust in the desired way the conductivity and consistency of the product according to the invention.

In a third preferred embodiment, the conducting varnish according to the invention is prepared from the (individual) constituents of a commercial conducting varnish and the (individual) constituents of a die spacer. In this way, the composition of the product according to the invention can be modified in any way.

The constituents of the currently known commercial spacers or the currently known commercial conducting varnishes are known to a person skilled in the art. Such spacers or conducting varnishes comprise, inter alia, binders (mainly in the role of film-forming agents), pigments, fillers, solvents and (additional) additives and auxiliaries, such as, for example, fungicides, screening agents, plasticizers, drying agents and the like. The most varied materials are used as binder, such as, for example, nitrocellulose, epoxide resins, alkyd resins, polyester resins, acrylic resins and more besides. In addition, the solvents/diluents used are known to a person skilled in the art and include first and foremost organic solvents, preferably polar organic solvents, such as alcohols, ketones and more besides.

In a particularly preferred embodiment of the invention, the new conducting varnish comprises at least one further component, preferably at least one colorant, which gives rise to an alteration in color or a change in color when the conducting varnish is dried. Such components, for example colorants or pigments, are already known. They are already used in die spacers to give the user an indication of the drying condition of this spacer. The invention now makes use of this knowledge in the abovementioned preferred embodiments by also including such a component in the conducting varnish according to the invention. Through the combination of the components included in the conducting varnish according to the invention, in particular through the combination of the “monitoring component” (colorant with alteration in color/change in color) and “electrically conducting component”, particular advantages can arise with the new conducting varnish, which advantages greatly facilitate and improve the preparation of electrodeposited dental moldings.

This is at this point to be explained briefly in principle.

As is shown yet later from the examples, a conducting varnish according to the invention can be prepared from a known spacer with monitoring component (or from its constituents) and silver as electrically conducting component (or from a corresponding conducting varnish). Such a conducting varnish according to the invention shows, for example, a silver-orange color. If this conducting varnish is applied to a nonabsorbent support (see above), then an alteration in color/change in color from silver-orange to silver-pink, which can be clearly recognized by the user, occurs when the conducting varnish is dried. In this connection, this change in color gives not only information on the respective drying condition of the conducting varnish but also on the layer thickness of the conducting layer applied with the help of the conducting varnish. The thicker this conducting layer, the more intense the pink color appears to the user. In addition, the color of the conducting varnish produces a distinct color contrast with the support used which makes it possible for the user to clearly recognize imperfections, i.e. generally thus places not coated with the conducting varnish, and to repair these before the beginning of the electrodeposition process. Such imperfections were hitherto scarcely to be recognized without a microscope in the use of conventional conducting varnishes through the silvery color of these conducting varnishes. This concerns in particular the metallic stump materials which are mostly themselves likewise silver-gray to delicate gold in color. This representation thus shows the advantages which are available by using such monitoring components in the conducting varnish according to the invention.

The spacer used for the preparation of the new conducting varnish can, according to the invention, have any composition. This means that even spacers possessing a high degree of transparency or essentially colorless spacers can be present in the new conducting varnish. The “monitoring component” mentioned earlier can then optionally be added separately to the new conducting varnish. Spacers or their constituents which can be used with the invention can be purchased e.g. from the companies al dente dentalprodukte, Meckenbeuren, GER or YETI Dentalprodukte, Engen, GER.

The component which brings about the electrical conductivity is present in the conducting varnish according to the invention preferably in the form of particles or flakes. These particles or flakes are then present in the finished conducting varnish as suspended particles.

In continued fashioning, the component which brings about the electrical conductivity in the conducting varnish is preferably at least one metal or at least one metal alloy. A metal particularly to be mentioned in this connection is copper. In addition, mention may be made, as particularly preferred metals or metal alloys, of noble metals or the alloys comprising noble metals. These preferably usable noble metals are in particular silver or gold.

Additional preference is given to embodiments in which the component which brings about the electrical conductivity is present in the material, based on total amount thereof, in an amount of <50% by weight, preferably <40% by weight. Within the abovementioned limits, emphasis is placed, though, on materials or conducting varnishes in which the component which brings about the electrical conductivity is present in the material, based on total amount thereof, in an amount of between 33% by weight and 40% by weight, preferably in an amount of between 35% by weight and 38% by weight.

The figures for the amounts given with regard to the component which brings about the electrical conductivity also refer in this connection particularly to the metals used as such a component, preferably noble metals. Very generally and in particular in these embodiments, the advantage is revealed that the content of metal particles, for example silver particles, in the conducting varnish can be reduced in comparison with the commercial conducting varnishes/conducting silver varnishes known hitherto. Thus, conducting silver varnishes known hitherto usually comprise the silver in amounts of between approximately 40% by weight and approximately 70% by weight. As explained above, these amounts of silver can be reduced to <40%, in particular even distinctly below this, with the preferred embodiments according to the invention. This produces a significant improvement with regard to cost efficiency and also with regard to protection of the environment.

The combined content of binder in the new conducting varnish can, according to the invention, be varied within wide limits. Accordingly, for example, the consistency of the new conducting varnish can be varied within correspondingly wide limits. Preferably, the content of preferably organic binder is more than 5% by weight.

The viscosity of the spacer present in the new conducting varnish can indirectly have an influence on the consistency of the conducting varnish according to the invention. In this connection, it is preferable for the spacer present in the new conducting varnish to exhibit a viscosity of between 20 and 50 MPa, preferably of between 30 and 40 MPa. Of course, the viscosity of the new conducting varnish can, however, also be varied through the amounts of its remaining components, for example through the binder content or through the solvent content.

The discovery according to the invention results not only in the new electrically conducting material/conducting varnish represented hitherto but can also be represented in another way. Thus, first, the invention also results in the use of a die spacer or of the constituents of such spacers in the preparation of an electrically conducting material, in particular a conducting varnish, for the preparation, preferably by electrodeposition, of dental moldings. In spite of the use of such separators for decades in dental technology, no one hitherto had yet had the idea of modifying such spacers according to the invention and, in this way, of making available a new conducting varnish with improved properties.

Secondly, the invention can accordingly also be represented so that it includes a die spacer comprising at least one component which gives rise to an electrical conductivity. As explained above, this component, which establishes the electrical conductivity, is preferably present in the form of particles or flakes. This component is preferably a metal or a metal alloy, noble metals or alloys comprising noble metals being emphasized in this connection. Mention may be made, as examples of these metals, of copper and in particular silver or gold.

The advantages of the invention are to be again summarized and explained below.

With the help of the invention, a new conducting varnish can be prepared in a simple way which, in comparison with the commercial conducting varnishes known hitherto, exhibits clearly improved properties. As will yet emerge from the examples, not only can the properties of the adherence to different supports, the conductivity and the handling be improved but the drying time can in some cases also be clearly reduced with the conducting varnish according to the invention. Depending on the support, drying times of <15 min or even shorter still can be achieved here, which lies far below the drying times of conducting varnishes known hitherto. Accordingly, the entire electrodeposition process is feasible for the user within shorter times, which by and large clearly increases the cost efficiency of this method for him.

In addition, the conducting varnish according to the invention is suitable for all known supports/stump materials and leads, with all these materials, to good to very good results. The conducting varnish according to the invention is accordingly universally applicable, which greatly simplifies its application possibility for the user. He does not have to fall back on different conducting varnishes with different supports or take into consideration special features when using one conducting varnish for different supports. Within the framework of economic considerations, it is also to be emphasized that the component which brings about the conductivity in the conducting varnish according to the invention can frequently be available in a smaller amount than is the case with the conducting varnishes known hitherto.

The advantages of the invention are shown in a particular way in embodiments in which a “monitoring component” with a change in color/alteration in color during the drying process is present in the conducting varnish. As already explained, this indicates to the user, first, how thick the applied conducting layer is and, secondly, what the drying condition is. If the starting color (such as, for example, silver-orange) is still present, then the conducting varnish is still sufficiently moist and therefore workable. Accordingly, for example, thicker drops of varnish can even be applied without running the risk, as hitherto, of again displacing or destroying the already partially dried/hardened conducting layer.

An additional important advantage of the presence of the monitoring component in the conducting varnish is that the degree of mixing of the conducting particles, thus, for example, of the silver particles/silver flakes, in the new varnish can be much better assessed than was the case in the previous conducting varnishes. In the previous conducting varnishes, all the silver particles in the varnish, which is colorless to the eye, also show a silvery color when badly mixed. With the preferred embodiments of the new conducting varnish with, for example, a silver-orange color, satisfactory mixing can be recognized optically in it by the presence of a uniform silver-orange color. When badly mixed, orange-colored streaks can clearly be recognized between the silver particles.

The outlined and additional features of the invention emerge from the following description of the examples in combination with the dependent claims. In this connection, the individual features can in each case be realized on their own or in combination with one another.

### EXAMPLES

### Example 1

5 g of the varnish according to the invention are prepared as follows:

| Constituent | g | % by weight |
|---|---|---|
| Silver flakes (99.5% < 20 μm) | 1.80 | 36.0 |
| Thinner: (Yeti Dental, GER; Thinner | 0.69 | 13.80 |
| for spacer; Art. 510-0001) | | |
| Thinner (Wieland Dental + Technik, | 0.66 | 13.20 |
| GER; Thinner for conducting silver | | |
| varnish; Art. No.: 6629) | | |
| Spacer red (Yeti Dental, GER; Art. | 1.85 | 37.0 |
| 500-0001) | | |

The conducting silver varnish prepared can be applied very well and can be used for any indication. The drying time required is 5-8 min. It dries on plaster with a uniform silver color. On nonabsorbent stump materials, the color changes on drying from silver-orange to silver-pink. The conductivity of the layer produced is very good, so that, during electro-deposition, the gold primary layer produced grows in a very uniform way.

### Example 2

5.71 g of the varnish according to the invention are prepared as follows:

| Constituent | g | % by weight |
|---|---|---|
| Silver flakes (99.5% < 20 μm) | 2.07 | 36.25 |
| Thinner (Wieland Dental + Technik, | 1.72 | 30.12 |
| GER; Thinner for conducting silver | | |
| varnish; Art. No.: 6629) | | |
| Spacer red (Yeti Dental, GER; Art. | 1.92 | 33.63 |
| 500-0001) | | |

The conducting silver varnish prepared can be applied very well and can be used for any indication. The drying time required is 10 min. It dries on plaster with a uniform silver color. On nonabsorbent stump materials, the color changes on drying from silver-orange to silver-pink. The conductivity of the layer produced is very good, so that, during electro-deposition, the gold primary layer produced grows in a very uniform way.

### Example 3

4 g of the varnish according to the invention are prepared as follows:

| Constituent | g | % by weight |
|---|---|---|
| AGC ® Leitsilberlack (Wieland Dental + Technik, | 2.0 | 50.0 |
| GER; Art. No.: 6628) | | |
| Silver flakes (99.5% < 20 μm) | 1.00 | 25.0 |
| Spacer red (Yeti Dental, GER; Art. | 1.00 | 25.0 |
| 500-0001) | | |

The conducting silver varnish prepared is rather viscous. When administered, the varnish begins to harden very quickly, so that the application is carried out speedily with a brush. The drying time required is 13 min. It dries on plaster with a uniform silver color. On nonabsorbent stump materials, the color changes on drying from silver-orange to light silver-pink. The conductivity of the layer produced is good, so that, during electrodeposition, the gold primary layer produced grows in a very uniform way.

### Example 4

3 g of the varnish according to the invention are prepared as follows:

| Constituent | g | % by weight |
|---|---|---|
| AGC ® Leitsilberlack (Wieland Dental + Technik, | 1.5 | 50.0 |
| GER; Art. No.: 6628) | | |
| Spacer red (Yeti Dental, GER; Art. | 1.50 | 50.0 |
| 500-0001) | | |

The conducting silver varnish prepared can be applied very well. The drying time required is 12 min. It dries on plaster with a change in color from silver-orange to silver-shocking pink. On nonabsorbent stump materials, the color changes from silver-orange to strong silver-shocking pink on drying. The conductivity of the layer produced is good, so that, during electro-deposition, the gold primary layer produced grows in a very uniform way. In this case, it is particularly easy for the user to assess the condition of the conducting silver layer by the strong change in color on drying!

The advantages of the conducting silver varnish according to the invention according to example 4 in comparison with a commercial conducting varnish, with regard to the criteria and influencing variables described, are to be shown below in more detail by a comparison.

AGC® Leitsilberlack Wieland Dental+Technik, GER, Art.

No. 6628

Administration: brush

| Stump | Drying | | | |
|---|---|---|---|---|
| material | time | Adherence | Conductivity | Handling |
| Plaster | 15 min | very good | good | very good |
| Plastic | 45 min | acceptable | acceptable | acceptable, |
| | | | | careful |
| | | | | application |
| | | | | necessary |
| Ceramic | 60 min | acceptable | acceptable | satisfactory, |
| | | | | very careful |
| | | | | application |
| | | | | necessary |
| Primary | 60 min | acceptable | acceptable | satisfactory, |
| component | | | | careful |
| of a | | | | application |
| noble | | | | necessary |
| metal | | | | |
| double | | | | |
| crown | | | | |
| Titanium | 60 min | acceptable- | acceptable- | acceptable, |
| post | | satisfactory | satisfactory | careful |
| | | | | application |
| | | | | necessary |
| Primary | 60 min | poor; flow | poor, large | acceptable, |
| component | minimum | pattern; | potential | careful |
| of a non- | | wrinkling; | differences, | application |
| noble- | | infiltration | imperfections | necessary |
| metal | | | | |
| double | | | | |
| crown | | | | |

Conducting silver varnish according to the invention as claimed in example 1

Administration: brush

| Stump | Drying | | | |
|---|---|---|---|---|
| material | time | Adherence | Conductivity | Handling |
| Plaster | 10 min | very good | very good | very good; |
| | | | | pink shows |
| | | | | varnished |
| | | | | twice |
| Plastic | 15 min-60 min | good | very good | good; |
| | | | | careful |
| | | | | application, |
| | | | | pink shows |
| | | | | dried |
| Ceramic | 15 min | very good | very good | good; |
| | | | | careful |
| | | | | application, |
| | | | | pink shows |
| | | | | dried |
| Primary | 20 min | very good | very good | good; |
| component | | | | careful |
| of a | | | | application, |
| noble | | | | pink shows |
| metal | | | | dried |
| double | | | | |
| crown | | | | |
| Titanium | 20 min | very good | very good | good; |
| post | | | | careful |
| | | | | application, |
| | | | | pink shows |
| | | | | dried |
| Primary | 30 min | good; slight | very good | good; |
| component | | infiltration | | careful |
| of a non- | | in places | | application, |
| noble- | | | | pink shows |
| metal | | | | dried |
| double | | | | |
| crown | | | | |

1-23. (Cancelled)

24. An electrically conducting material, in particular a conducting varnish, for the preparation, preferably by electrodeposition, of dental moldings, comprising at least
one component which brings about the electrical conductivity and
one dental spacer or die spacer or the constituents of such a spacer.

25. The electrically conducting material of claim 24, wherein it is prepared from the component which brings about the electrical conductivity and a finished die spacer.

26. The electrically conducting material of claim 24, wherein it is prepared from a commercial conducting varnish, which comprises the component which brings about the electrical conductivity, and a finished die spacer.

27. The electrically conducting material of claim 24, wherein it is prepared from the constituents of a commercial conducting varnish and the constituents of a die spacer.

28. The electrically conducting material of claim 24, wherein it comprises at least one additional component, in particular at least one colorant, which gives rise to an alteration in color or a change in color when the electrically conducting material is dried.

29. The electrically conducting material of claim 24, wherein it comprises a spacer which is to a large degree transparent.

30. The electrically conducting material of claim 24, wherein it comprises an essentially colorless spacer.

31. The electrically conducting material of claim 24, wherein the component which brings about the electrical conductivity is present in the form of particles or flakes.

32. The electrically conducting material of claim 24, wherein the component which brings about the electrical conductivity is at least one metal or at least one metal alloy.

33. The electrically conducting material of claim 32, wherein the metal is copper.

34. The electrically conducting material of claim 32, wherein the metal or the metal alloy is a noble metal or an alloy comprising a noble metal.

35. The electrically conducting material of claim 34, wherein the noble metal is silver.

36. The electrically conducting material of claim 34, wherein the noble metal is gold.

37. The electrically conducting material of claim 24, wherein the component which brings about the electrical conductivity is present in the material, based on total amount thereof, in an amount of <50% by weight, preferably <40% by weight.

38. The electrically conducting material of claim 37, wherein the component which brings about the electrical conductivity is present in the material, based on total amount thereof, in an amount of between 33% by weight and 40% by weight, preferably in an amount of between 35% by weight and 38% by weight.

39. The electrically conducting material of claim 24, wherein the content of preferably organic binder in the material is more than 5% by weight.

40. The electrically conducting material of claim 24, wherein the spacer present in the material exhibits a viscosity of between 20 and 50 Mpa, preferably of between 30 and 40 Mpa.

41. A dental spacer or die spacer, which comprises at least one component which brings about an electrical conductivity.

42. The spacer as of claim 41, wherein the component which brings about the electrical conductivity is present in the form of particles or flakes.

43. The spacer of claim 41, wherein the component which brings about the electrical conductivity is a metal, preferably a noble metal, or a metal alloy, preferably an alloy comprising a noble metal.

44. The spacer of claim 43, wherein the metal is copper.

45. The spacer of claim 43, wherein the noble metal is silver or gold.
